(19) United States
(12) Patent Application Publication
(10) Pub. No.: US 2002/0186975 A1
(43) Pub. Date: Dec. 12, 2002

(54) Apparatus and method for generating a picture copy from an original picture

(76) Inventor: Josef Lindthaler, Bad Oeynhausen (DE)

Correspondence Address: Thomas R. Vigil, c/o Vigil & Associates, 836 South Northwest Highway, Barrington, IL, 60010, US

(21) Appl. No.: 09/844,561

(22) Filed: Apr. 27, 2001

(30) Foreign Application Priority Data
Apr. 27, 2001 (DE) 100 20 610.7-31

(51) Int. Cl. G03B 17/48

(52) U.S. Cl. 396/429

(57) ABSTRACT

The subject matter of the invention is a method and an apparatus for generating a picture from an original picture, more specifically for photo labs, comprising an original picture input station, a camera and a holding device for holding the camera, whereas the device may be connected to an electronic computing and storing unit. Creation of an apparatus for generating a picture from an original picture which photographs the original picture as blur-free as possible in order to achieve a sharp reproduction of the original picture of concern is either achieved in that the camera is designed as a 3-chip camera (16) and is placed behind a prism divider (30) for producing a red, a green and a blue copy of the original picture, each copy being captured by a camera chip, and a method suiting the apparatus, or in that the original picture input station is designed as an original picture carrier (14) that may be traveled in four directions.

The present invention relates to an apparatus for generating a picture copy from an original picture (picture from picture), more specifically for photo labs, comprising an original picture input station, a camera and a holding device for holding the camera, whereas the device may be connected to an electronic computing and storing unit and to a method for generating a picture from an original picture, more particularly for photo labs, at least two, preferably three monochromatic copies of different color being produced from the original picture, whereas these monochromatic copies are captured and digitized by a camera and processed further in an electronic computer.

The term original picture includes all kinds of pictures, that is pictures that have been photographically developed, printed or painted manually, on paper or on films, slides, negatives and so on.

EP 533 109 A2 discloses a photo scanner with two original picture input stations comprising a camera and a holding device for holding the camera, in which the respective originals are conveyed to the desired place by means of an original picture carrier. Instead of one single picture, the original picture carrier may also carry several pages comprising pictures. The data concerning the original picture such as the size of the picture, the format of the picture, the quality of the pictures, or the like are entered together with the original picture. By means of these data, a zoom placed in front of the camera is automatically adjusted in such a manner that the area of the camera is filled out as best as possible by the original picture for the purpose of minimizing unwanted margins and so on. As a result, unwanted data are prevented from being captured on one side and, on the other, the copy of the original picture is represented as largely as possible by possibly completely illuminating the CCD chip in order to obtain as sharp a reproduction of the original picture as possible. This however assumes that the center of the original picture is accommodated in the optical axis of the zoom. To achieve this, the original picture carrier is manually brought in feeding direction into position in the center and may then also be centrally positioned crosswise to the feeding direction. This process is monitored on the display by the operator, the photography being shot only when the original picture carrier is in the desired position. It is evident that such a manual adjustment of the original picture is time-consuming and expensive. In a second original picture input station, the pictures are merely manually placed into the original picture carrier and then, this original picture carrier is automatically brought into the desired position so that the original picture carrier is then photographed in full size. This procedure is less labor-consuming and more original pictures can be processed in less time. However, if the original picture is smaller than the original picture carrier (which is most often the case), the camera not only captures the image but also data since in that case the original picture usually is not accommodated in the optical axis of the zoom. Accordingly, a lot of useless data are captured which later impair the electronic interpretation and the actual original picture is not optimally photographed so that the reproduced picture is blurred.

To overcome the last-mentioned drawbacks, the firm Gretag Imaging Inc., Chicopee, Mass. 01022 U.S.A. created a camera scanner called “Selexxa DRS-200” intended to produce a copy of an original picture, more specifically for photo labs, in which the original picture is placed into a linearly slidable original picture carrier before said carrier is traveled under the camera. Then, the camera, which is slidably held on a holding device, is traveled vertically and horizontally until the camera properly detects and focuses the original picture, more specifically until the original picture is being projected in as large a size as possible onto the CCD chip. Once the individually required exposure time has been determined and adjusted, three reproductions of the original picture are taken. These three reproductions differ in that they are provided with a red, a green and a blue filter respectively. The thus digitally obtained images are then fed to an electronic computer and processed into a saleable image.

On traveling the camera, the entire system, the camera and its holding device in particular, is caused to vibrate. Considering that such devices for producing a picture from an original picture make up to 500 reproductions per hour, it becomes obvious that the oscillations and vibrations occasioned by the traveling camera have not completely died away at the time the diaphragm opens. This occasions the blurs in the image. Although it would be possible to wait for the vibrations and/or oscillations to have died away before taking the picture, the number of images per unit time, and accordingly efficiency, would strongly drop.

In the camera scanners according to the firm Gretag and according to EP 533 109 A1, the successive photographing of the three color images causes blurs to occur on account of the opening and closing of the diaphragm or the shifting of the color filters so that the three color pictures are not completely identical. On electronically combining these three color pictures, blurs occur that cannot even be corrected by electronic processing.

In view of the above described state of the art, it is the object of the present invention to provide an apparatus and a method for generating a picture from an original picture in which the original picture is captured as blur-free as possible in order to obtain a sharp reproduction of the original picture of concern.

The invention suggests, as a first technical solution to this object, a development of the apparatus mentioned herein above which has the camera designed as a 3-chip camera and is placed behind a prism divider for producing a red, a green and a blue copy of the original picture, each copy being detected by a camera chip.

The invention suggests, as a further solution to this object, a development of the method mentioned herein above in which the original picture is simultaneously divided into two or three monochromatic pictures of different colors by means of a prism divider and in which the copies are concurrently detected and digitized by means of a 3-chip camera.

An apparatus designed in accordance with this technical teaching and a method operating in accordance with this technical teaching have the advantage that the three monochromatic pictures created by the prism divider impinge concurrently on the CCD chip of the camera and are captured simultaneously. Accordingly, all three color pictures are completely identical and have the same blurs so that genuinely sharp pictures may be generated in the course of electronic processing.

Another advantage lies in the fact that the prism transmits the occurring vibrations, if at all, evenly to the three color pictures so that possible jolts do not cause the picture to become corrupted.

In this connection it proved particularly advantageous to use a high-resolution 3 Chip CCD analog area camera and a prism divider of the firm JVC.

In a preferred development of the method according to the invention, the invention suggests detecting the position of the original picture by detecting its edges and not to store data that do not pertain to the original picture. As a result thereof, the volume of data is considerably reduced so that the pictorial processing of the image may be performed faster and that the required storing location may be reduced. Another advantage lies in the fact that it is no longer necessary, as a result thereof, to zoom the original picture so that the preparation time per picture is reduced, which results in a higher throughput of pictures.

The invention suggests, as a second solution to this object, a development of the apparatus mentioned herein above in which the original picture input station is designed as an original picture carrier that may be traveled in four directions.

The advantage of an apparatus realized according to this technical teaching is that the original picture can quickly and easily, if need be even automatically, be brought to align its center on the optical axis of the camera thanks to the original picture carrier that is movable in all directions. As a result thereof, it is no longer necessary to travel the camera, so that said camera may now be rigidly mounted on the holding device. In that the camera does not move, vibrations, oscillations or jolts can no longer occur.

Another advantage lies in the fact that this makes it possible to constructively uncouple the camera from the original picture carrier so that possibly occurring vibrations, oscillations or jolts are no longer transmitted onto the camera.

In another, preferred development, the original picture carrier is provided with a suction device, the original picture being held in the original picture carrier by negative pressure by means of a number of aspirating ports. A reliable fixation of the original picture while the original picture carrier is being traveled is thus achieved. Moreover, as a result thereof, undulated or dog-eared original pictures are stretched to become plane on the original picture carrier, thus making perfect reproduction possible.

In a preferred development, the camera comprises a zoom lens, preferably a motor zoom lens. The advantage thereof lies in the fact that the original picture may be magnified or scaled down in such a manner that the CCD chip is entirely filled so that a best possible reproduction of the original picture can be achieved, which results in as sharp and accurate an image of the original picture as possible.

In having more specifically the zoom objective carried in an appropriate oil sliding bearing, the oscillations and vibrations caused by the travel of the objective may be reduced.

In a particularly preferred development, sensors are provided in the original picture carrier by means of which the size of the original picture may be detected. The thus determined data permit to automatically adjust the corresponding cutout of the picture (zoom) in the (motor) zoom lens, to optimize the focus and to alter the diaphragm (iris) according to the parameters of the lens. This already occurs when the original picture is being entered so that a much faster processing of the original picture is made possible.

Further advantages of the device according to the invention will become apparent in the drawing and in the following description of embodiments. The features mentioned herein above and those described below may be used alone or in any combination in accordance with the invention. The invention is not considered limited to the embodiments mentioned, which have been given as examples.

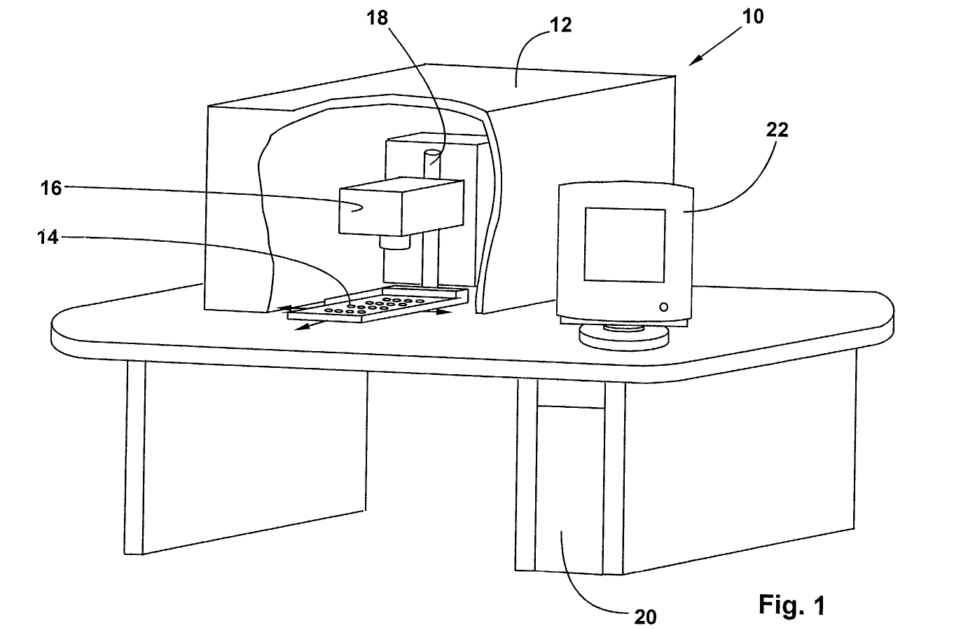

FIG. 1 shows a schematic, exploded view of a device according to the invention;

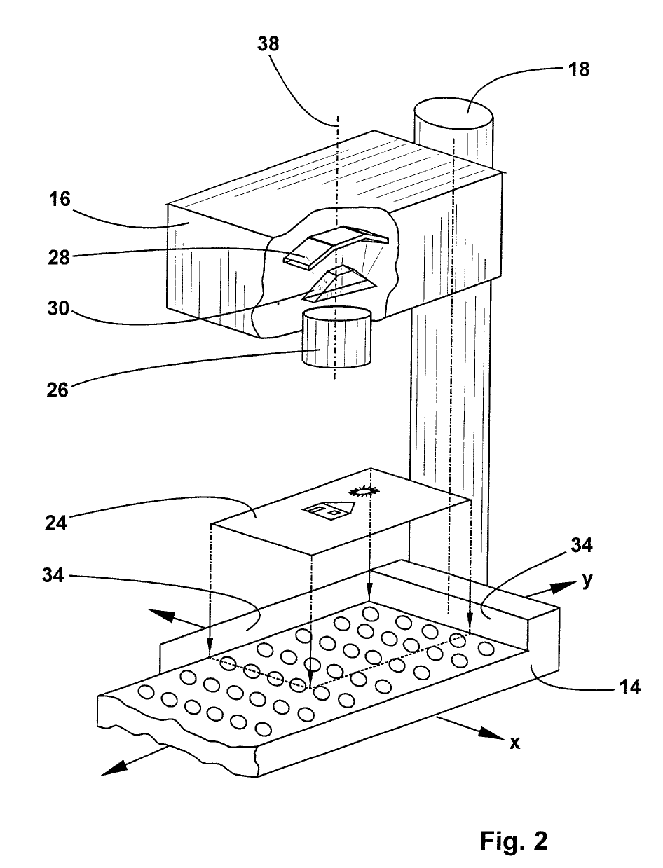

FIG. 2 shows a perspective view of the camera, of the holding device and of the original picture carrier of the device according to FIG. 1.

FIG. 1 shows a complete workstation for generating a picture from an original picture, more specifically for photo labs. The device required for this purpose, that is for generating a picture from an original picture is designed as a camera scanner 10 and comprises a housing 12 that has been broken up, an original picture carrier 14 that may be traveled on a horizontal plane for capturing an original picture that has not been illustrated in the drawing, a camera 16 and a holding device 18 for keeping the camera 16 in the desired position. This camera scanner 10 is connected to an electronic computer 20 so that the captured images may be appraised and if need be processed further by way of the display 22 of the computer.

FIG. 2 shows an enlargement of the core piece of the camera scanner 10, an original picture 24 being represented in a raised, exploded view for the purpose of better showing its positioning on the original picture carrier 14. The camera 16 illustrated in the drawing herein is a high-resolution analog area camera which is stationarily accommodated on the holding device 18. This high-resolution, digital analog area camera comprises a motor zoom lens 26 provided with oil sliding bearings, a 3-CCD-chip 28 that is subdivided into three portions and a prism divider 30 that is arranged between the motor zoom lens 26 and the 3-CCD-chip 28. As contrasted with the state of the art, in which the CCD chip must be exposed at three subsequent times with the respective filter, with the camera scanner 10, the picture to be taken is divided into its red, green and blue color by means of the prism divider 30 and the respective pictures are fed to the corresponding portion of the 3-CCD-chip 28 so that the three different color pictures are generated by one unique photograph.

As contrasted with the state of the art, with the camera scanner 10 it is not the camera 16 which is vertically traveled to focus the original picture 24, but merely individual lenses of the motor zoom lens 26. Oscillations and vibrations of the camera 16 and of the holding device 18 are considerably reduced as a result thereof, more particularly when the motor zoom lens 26 is carried in an oil sliding bearing.

Furthermore, with the camera scanner 10, the alignment of the picture is not performed by horizontally shifting the camera, but by horizontally shifting the original picture carrier 14 which holds the original picture 24. This means that, as work starts, the original picture carrier 14 is located outside the housing 12 of the camera scanner 10 so that the operator may place the original picture 24 into the original picture carrier 14. It is advantageous to hereby take care that the original picture 24 abuts the contacting edges 32 and 34. After the original picture 24 has come into flush contact with the contacting edges 32 and 34, a suction device is switched on which aspires ambient air through the aspiration ports 36. As a result thereof, the original picture 24 is fixated in the original picture carrier 14 so that possible undulations or dog-ears are smoothed out. Accordingly, the original picture 24 lies plane in the original picture carrier 14. In this position, the size of the original picture 24 is determined and its center computed by way of sensors that have not been illustrated in the drawing herein and that are provided in the original picture carrier 24. Then, the original picture carrier 14 is horizontally traveled in X- and -Y direction in such a manner that the center of the original picture 24 is flush with the optical axis 38 of the camera 16. Meanwhile, on account of the determined size of the original picture 24, the focus is determined in the electronic computer 20 and the motor zoom lens 26 is brought into the corresponding position. Now, the original picture 24 is photographed and the thus obtained picture data are stored and processed in the connected electronic computer and may then be printed or exposed on an appropriate printer, laser exposure timer and so on.

The electronic computer 20 determines the precise margins of the captured picture by means of margin detection and only stores the data located within these margins. The data located outside the margins are hereby deleted. As a result thereof, the volume of data is considerably reduced so that the pictorial processing of the reproduction may be performed faster and so that the storage location may be reduced. This renders zooming of the original picture superfluous so that the preparation time per picture is reduced, which results in a higher picture throughput.

In another embodiment that has not been illustrated in the drawing herein, positioning of the original picture in the original picture carrier and/or horizontal alignment of the original picture carrier may also occur automatically.

In another embodiment that has not been illustrated in the drawing herein, the camera 16 may also be provided with three separate CCD chips for capturing the three pictures produced by the prism divider 30.

Listing of numerals:

| | |
|---|---|
| 10 | camera scanner |
| 12 | housing |
| 14 | original picture carrier |
| 16 | camera |
| 18 | holding device |
| 20 | electronic computer |
| 22 | display |
| 24 | original picture |
| 26 | motor zoom lens |
| 28 | 3-CCD-chip |
| 30 | prism divider |
| 32 | contacting edge |
| 34 | contacting edge |
| 36 | aspiration port |
| 38 | optical axis |

1. Apparatus for generating a picture from an original picture, more specifically for photo labs, comprising an original picture input station, a camera and a holding device for holding the camera, whereas the device may be connected to an electronic computing and storing unit, characterized in that the camera is designed as a 3-chip camera (16) and is placed behind a prism divider (30) for producing a red, a green and a blue copy of the original picture respectively, each copy being detected by a camera chip.

2. Apparatus for generating a picture from an original picture, more specifically for photo labs, comprising an original picture input station, a camera and a holding device for holding the camera, whereas the apparatus may be connected to an electronic computing and storing unit, more specifically according to claim 1, characterized in that the original picture input station is designed as an original picture carrier (14) that may be traveled in four directions.

3. Apparatus according to claim 2, characterized in that the original picture input station comprises a suction device that holds the original picture (24) in the original picture carrier (14) by means of negative pressure by way of a number of aspirating ports provided in the original picture carrier (14).

4. Apparatus according to one of the previous claims, characterized in that the camera (16) comprises a zoom lens (26).

5. Apparatus according to claim 4, characterized in that the zoom lens (26) is carried in an oil sliding bearing.

6. Apparatus according to one of the claims 2 through 5, characterized in that the original picture carrier (14) contains sensors for detecting the size of the original picture (24).

7. Method for generating a picture from an original picture, more particularly for photo labs, at least two, preferably three monochromatic copes of different color being generated from the original picture, whereas these monochromatic copies are captured and digitized by a camera and processed further in an electronic computer, characterized in that the original picture is simultaneously divided into two or three monochromatic copies of different color by means of a prism divider and that the copies are concurrently detected and digitized by means of a 3-chip camera.

8. Method according to claim 7, characterized in that the position of the original picture is detected by detecting its edges and that data that do not pertain to the original picture are not stored.
